(19) United States
(12) Patent Application Publication
(10) Pub. No.: US 2026/0030361 A1
(43) Pub. Date: Jan. 29, 2026

(54) AUDITING AND REMEDIATING IDENTIFIED SECURITY VULNERABILITY IN SOURCE CODE USING LLM

(71) Applicant: MICRO FOCUS LLC, Wilmington, DE (US)

(72) Inventors: Franciscus Henricus Arnoldus van Buul, Montfoort (NL); Alexander Michael Hoole, Vancouver (CA); Carl Emil Orm Wareus, Malmo (SE)

(73) Assignee: MICRO FOCUS LLC, Wilmington, DE (US)

(21) Appl. No.: 18/784,831

(22) Filed: Jul. 25, 2024

(51) Int. Cl. G06F 21/57; G06F 40/30

(52) U.S. Cl. CPC G06F 21/577; G06F 40/30

(57) ABSTRACT

Information is received that pertains to a security vulnerability of a program identified by security testing. The information includes the security vulnerability and the source code responsible for the security vulnerability. Based on the information pertaining to the security vulnerability, a prompt is generated to input to a large language model (LLM). The prompt is generated to solicit a response from the LLM including whether the security vulnerability is an actual security vulnerability; a justification as to why the LLM has indicated that the security vulnerability is an actual security vulnerability or not; and in a case in which the security vulnerability is an actual security vulnerability, a recommended fix to resolve the security vulnerability.

### BACKGROUND

Computing devices like desktops, laptops, and other types of computers, as well as mobile computing devices like smartphones, and other types of computing devices, run software, which can be referred to as applications, to perform intended functionality. An application may be a so-called native application that runs on a computing device directly, or may be a web application or “app” at least partially run on a remote computing device accessible over a network, such as via a web browser running on a local computing device. An application can be tested, or analyzed, in a variety of different ways to ensure that the application correctly performs its intended functionality as well as to ensure that the application does not have any security vulnerabilities. An application is one type of computer program, or program, where such a program can also be referred to as software.

### BRIEF DESCRIPTION OF THE DRAWINGS

FIG. 1 is a diagram of an example process for using a large language model (LLM) to analyze security vulnerabilities of a program that have been identified by security testing.

FIG. 2A is a diagram of example information pertaining to a security vulnerability that can be provided when security testing has identified the security vulnerability.

FIG. 2B is a diagram of an example LLM prompt for a security vulnerability that is generated based on information pertaining to the security vulnerability, which is provided to an LLM to analyze the vulnerability.

FIG. 2C is a diagram of an example analysis response for a security vulnerability that is received from in LLM upon providing an LLM with a prompt for the vulnerability.

FIG. 2D is a diagram of an example recommended fix to apply to source code of a program to resolve a security vulnerability, which can be included in the analysis response received from an LLM.

FIG. 3 is a non-transitory computer-readable data storage medium storing example program code for using an LLM to analyze a security vulnerability in a program identified by security testing.

FIG. 4 is a diagram of an example computing system for using one or more LLMs to analyze security vulnerabilities of a program that have been identified by security testing.

FIG. 5 is a diagram of an example process for using an LLM to analyze security vulnerabilities of a program and for updating source code of the program based on the LLM's analysis before building (and subsequently running) executable code of the program from the updated source code.

### DETAILED DESCRIPTION

As noted in the background, an application, which is one type of computer program (and where such a program can also be referred to as software), can be tested to ensure that it performs its intended functionality as well as to ensure that it does not have any security vulnerabilities. Vulnerabilities in software may be the result of design flaws, misconfigurations, and/or coding flaws, including identified by the Common Weakness Enumeration (CWE) taxonomy or Fortify Taxonomy of Software Security Errors. Vulnerabilities in software, such as command injection, SQL injection, privacy violation, buffer overflow and underflow, and the like can be detected via application security testing.

One type of application testing that is performed particularly to identify security vulnerabilities is known as static application security testing (SAST). SAST involves analyzing the source code of an application to determine whether subsequent execution of the application will have security vulnerabilities. SAST is static in that the application is not actually executed (i.e., executable code for the application is not generated from the source code and/or is not executed) to identify security vulnerabilities. In other words, SAST utilizes only the source code of an application and does not consider the application when it is actually running.

Other, non-SAST techniques include, among others, dynamic application security testing (DAST) and interactive application security testing (IAST). DAST identifies security vulnerabilities within an application as the application is running (i.e., during execution of the executable code for the application), such as in a production environment in which the application is being used by end users. Unlike SAST, DAST utilizes only the executable code of the application and considers the application when it is actually running. IAST identifies security vulnerabilities within an application during automated or human-assisted testing of the application while the application is running, and can identify the source code responsible for identified security vulnerabilities. Unlike SAST and like DAST, IAST utilizes the executable code of the application and considers the application when it is actually running, but unlike DAST can reference the source code of the application. Still other, non-SAST techniques include runtime application self-protection (RASP) and software component analysis (SCA), among others.

The security vulnerabilities that are identified by performing SAST or another type of security testing can include false positives. That is, the identified security vulnerabilities can be considered as potential or possible vulnerabilities, and may not be actual security vulnerabilities. Suspected vulnerabilities detected through SAST are often referred to as detected weaknesses or flaws. Therefore, once security testing has been performed, a skilled user may have to audit the identified security vulnerabilities to determine whether each is an actual vulnerability (i.e., a true positive) or not (i.e., a false positive).

More generally, the vulnerability may be classified over multiple discrete classes as opposed to just two classes (e.g., true positive or false positive). For example, there may be three classes, such as true positive/exploitable, false positive/not an issue, or unsure/unknown). The vulnerability may instead by classified more continuously, such as the believed likelihood that the vulnerability is an actual vulnerability and/or a confidence value as to this assessment. The auditing process can be laborious, since hundreds, thousands, or even tens of thousands if not more vulnerabilities may be identified. Moreover, the number of skilled users who can perform the auditing process may be limited in an organization.

Additionally, once the identified security vulnerabilities have been audited to remove false positives, the source code of the program may have to be modified or other actions may have to be performed to resolve or at least ameliorate the actual vulnerabilities. A skilled user, for instance, may have to review each actual security vulnerability and provide a recommended fix to apply to the source code to resolve the vulnerability. This process can involve a different skill set than the auditing process, and therefore may have to be performed by a different user than the user who performed the auditing process. This process can also be laborious, and the number of skilled users who can perform the recommended fix generation process may likewise be limited. Ultimately, then, even if security vulnerability identification is automated, auditing and resolving the identified security vulnerabilities can still be time consuming and costly.

Techniques described herein leverage large language models (LLMs) to analyze security vulnerabilities of a program that are identified by security testing, such as that which is performed on source code of the program. The analysis can include auditing the security vulnerabilities to identify those that are actual vulnerabilities, as well as providing recommended fixes for the security vulnerabilities, among other information. The auditing and recommended fix generation processes can be effectively merged. For instance, an LLM prompt can be generated based on information pertaining to a security vulnerability and provided as input to an LLM, with the response received as output from the LLM then including whether the vulnerability is a true positive, a human-readable justification as to why the vulnerability has been considered a true positive, as well as a recommended fix.

The prompts can be generated on a per-security vulnerability basis, and may be individually provided to the LLM such that a response is separately received for each vulnerability. The invocation of the LLM on a per-security vulnerability basis beneficially limits individual prompt size and permits parallelization of LLM invocations. For the security vulnerabilities that the LLM has audited as true positives, the recommended fixes generated by the LLM may then be applied to the source code, for instance. Once the source code has been updated in this manner, in the case of source code written in compilable programming languages, executable code of the program may be built or constructed from the updated source code and then run. In the case of source code written in interpretable programming languages, the source code can simply be run once having been updated. The techniques described herein can thus be used to automatically provide for the generation (and subsequent execution) of executable code of a program in which security vulnerabilities have been resolved or at least ameliorated.

LLMs are thus used herein to provide auditing and remediation of security vulnerabilities that have been identified in a program. For instance, in one implementation, a single prompt may be sent to a pre-trained LLM. In other implementations, variations on this basic technique can be made to increase accuracy and/or efficiency. Examples of such variations include fine-tuning an LLM for this specific task (i.e., transfer learning in which the parameters of a pre-trained model are trained on new data); using prompt chaining to guide the LLM in its reasoning; and using prompt chaining to provide feedback to the LLM on its initial response, allowing the LLM to adjust as appropriate.

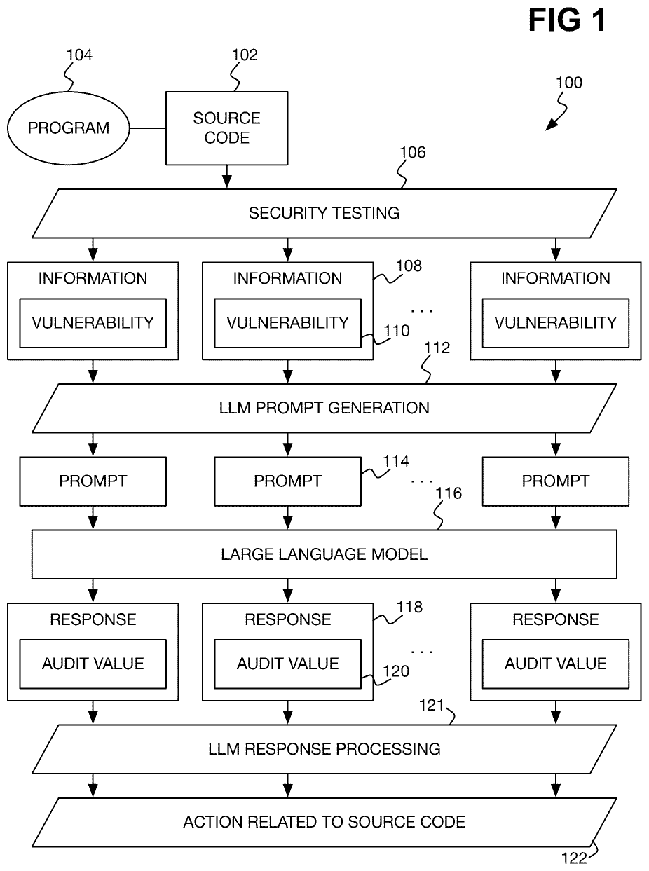

FIG. 1 shows an example process 100 for using an LLM 116 in this respect. A program 104 may be a complete application program, a dependency of program such as a library or framework, or any portion thereof. Source code 102 of the program 104 may be written in a programming language such as C, C#, or another type of programming language. In the example, the source code 102 is subjected to security testing (106), such as SAST or another type of security testing, to identify security vulnerabilities 110 within the program 104. For each security vulnerability 110 identified by the security testing, the security testing may provide information 108 (which includes the vulnerability 110 itself).

LLM prompts 114 are individually generated for the identified security vulnerabilities 110 (112), based on the information 108 regarding them. Each prompt 114 is generated to solicit a response 118 for the security vulnerability 110 to which the prompt 114 corresponds from the LLM 116, where the response 118 includes at least what is referred to herein as an audit value 120. The audit value 120 is an indication as to whether its corresponding security vulnerability 110 is an actual vulnerability (i.e., a true positive) or not (i.e., a false positive).

As noted above, the audit value 120 can more generally be a discrete classification over more than two categories (i.e., true positive or false positive); for example, there may be three categories: exploitable; not an issue; and unsure/unknown. The audit value 120 may instead be a more continuous classification as to the likelihood or probability that the vulnerability 110 is an actual vulnerability, and can further include a degree of confidence in the classification that has been made.

The generated prompts 114 are therefore individually provided as input to the LLM 116, and the responses 118 to the prompts 114 are individually received as output from the LLM 116. The LLM 116 may be GPT-4 or newer (available from OpenAI, Inc.); Claude 3 Sonnet or Opus or newer (available from Anthropic PBC); Gemini Pro 1.5 or Ultra or newer (available from Google LLC); or Llama 3 70B Instruct or newer (open source, available from Meta Platforms, Inc.); among others. The LLM responses 118 may undergo processing (121), such as validation of the responses 118 and subsequent extraction of the audit values 120 and other information therefrom, for instance.

Actions 122 related to the source code 102 of the program 104 may then be performed based on the responses 118 received from the LLM 116 in response to the prompts 114. The actions 122 can include simply outputting or displaying the audit values 120 and/or other portions of the responses 118, as well as resolving or at least ameliorating the vulnerabilities 110 based on the responses 118.

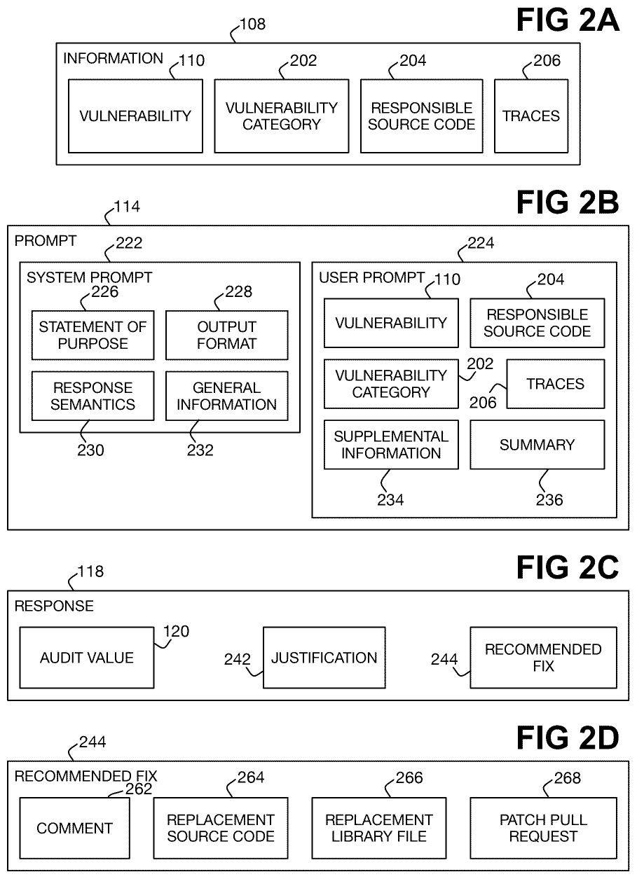

FIG. 2A shows example information 108 pertaining to a security vulnerability 110 identified by application security testing that has been performed. The information 108 may be completely or partially provided as output by the security testing. For instance, some portions of the information 108 may be provided by the security testing itself, and then supplemented with other portions of the information 108 for the identified security vulnerability 110. The information 108 for a security vulnerability 110 can be formatted in a markup language, such as the extensible markup language (XML) and JavaScript object notation (JSON), among other examples. There may be one XML or JSON file for all the identified security vulnerabilities 110, which individually lists the information 108 for each individual vulnerability 110.

The information 108 pertaining to a security vulnerability 110 includes the vulnerability 110 itself. The security vulnerability 110 may be specified in the information 108 as a particular instance identifier that is unique to that vulnerability 110, and may include other information such as the severity of the vulnerability 110 and the indicated confidence of the security testing in having identified the vulnerability 110.

The information 108 pertaining to a security vulnerability 110 can also include one or more pieces of other information 108. For instance, the information 108 can include the category 202 of the security vulnerability 110. Example security vulnerability categories 202 include hardcoded keys and passwords, SQL injection, cross-site-scripting, and other security vulnerabilities that can be detected by taint-analysis, buffer-analysis, structural analysis, and other techniques algorithms. The security vulnerability 110 may thus be classified as one of tens, hundreds, or thousands of different potential categories 202 of security vulnerabilities.

The vulnerability category 202 may be specified in the information 108 as a particular class identifier that is unique to that category 202, as well as provide additional metadata, such as its type and the type of analysis that resulted in its detection. Other information regarding the class may also be present, such as the default severity of security vulnerabilities in the category 202 and the name of the analyzer (i.e., the particular section of the security testing) that identified the vulnerability.

The information 108 pertaining to a security vulnerability 110 can include the responsible source code 204 that caused the security testing to identify the vulnerability 110, in the case where the security testing was performed on the source code 102, for instance. More generally, the source code 204 may be considered as the source code that is responsible for the vulnerability 110 having been identified by the security testing. The source code 204 may be or may reference one or more lines of the overall source code 102 of the program 104 that triggered the vulnerability 110. The source code 204 may be provided on a source code line basis (i.e., the particular lines of the source code 102 that triggered the vulnerability 110), or on a function basis (i.e., the function in the source code 102 including the particular lines that triggered the vulnerability 110).

The responsible source code 204 may be identified in the information 108 as a context including the function name, namespace, and the location of files or file fragments including the function and namespace in question. The responsible source code 204 can include these actual files or file fragments, or refer to line numbers or functions of the files or file fragments of the source code 102. As compared to complete files, file fragments are portions of files, and the files or file fragments may include files or file fragments other than those of the source code 102 if such other files or file fragments were responsible for the security vulnerability 110 having been identified in the source code 102

The information 108 pertaining to a security vulnerability 110 can include traces 206 of the program 104 when the security testing identified the security vulnerability 110. The traces 206 may be considered evidence regarding the program 104 when the security testing identified the security vulnerability 110. Examples of such traces 206 include stack traces, call graph traces, taint traces, state transitions, and so on.

For example, in the case of stack traces, such traces represent a list of code locations (files, methods, line numbers) that were or would be executed at the point of the vulnerability 110. The stack traces may be identified in the information 108 as at least a primary trace, and also potentially as one or more secondary traces, with each such trace identifying every entry node of the trace, including information regarding the node.

The information 108 more generally, therefore, includes the security vulnerability 110, and can also include the responsible source code 204 and metadata regarding the vulnerability 110. The metadata in the example includes the vulnerability category 202 and the traces 206, and can instead or additionally include other information as well.

FIG. 2B shows an example of a prompt 114 for a security vulnerability 110 that is generated and provided as input to the LLM 116. In the depicted example, the prompt 114 can include a system prompt 222 and a user prompt 224. The system prompt 222 is not specific to the security vulnerability 110 in question (i.e., it can be the same for every identified vulnerability 110, or at least for every vulnerability 110 in the same category 202), but can be specific to the particular LLM 116 to which the prompt 114 will be input. The user prompt 224, by comparison, is specific to the security vulnerability 110 in question, but may also depend on the particular LLM 116 to which the prompt 114 will be input. Each of the prompts 222 and 224 can be a separate file formatted in a markup language, such as XML or JSON.

It is noted, however, that in other implementations, the prompt 114 may not be divided between a system prompt 222 and a user prompt 224. For example, there may just be a single prompt constituting the prompt 114. A particular LLM 116, for instance, may not accept separate system and user prompts 222 and 224. In this case, the information ascribed to each of the prompts 222 and 224 below may be concatenated into a single prompt as the prompt 114.

The system prompt 222 can include a statement of purpose 226 of the LLM 116 as to its role and what the LLM 116 is expected to do in generating the response 118 for a security vulnerability 110 from the information 108 regarding the vulnerability 110. The statement of purpose 226 can be provided in natural language format. The statement of purpose 226 can indicate to the LLM 116 that it is expected to review and analyze the security vulnerability 110, and identify whether the LLM 116 believes the vulnerability 110 is an actual vulnerability or not (or more generally classify the vulnerability 110, as noted above). The statement of purpose 226 can provide limits to the LLM 116 as to the information the LLM 116 should consider when performing this analysis, and/or what information the LLM 116 should consider.

The statement of purposes 226 may be multiple sentences to multiple paragraphs in length. The role that the LLM 116 is to have may be provided as the type of human user the LLM 116 is to behave as when analyzing the security vulnerability 110. Providing this information in this way may be able to leverage whatever knowledge the LLM 116 has as to how a human use would analyze the vulnerability 110, for instance, as opposed to analyzing the vulnerability 110 in a manner that would otherwise be inscrutable when subjected to verification for correctness and completeness.

The system prompt 222 can include an output format 228 of the response 118 that the LLM 116 is to output for a security vulnerability 110. That is, when providing the response 118, the LLM 116 is expected to provide the response 118 in the output format 228. The output format 228 may also be provided in natural language form, describing in human-readable form how the various parts of the response 118 are to be returned. The output format 228 may specify, for instance, the type of document that the LLM 116 should output (e.g., an XML document or a JSON file), and the various elements in that document (e.g., XML or JSON elements). For each element, the output format 228 can specify the possible values that the LLM 116 can select for the element.

The system prompt 222 can include response semantics 230 of the response 118 that the LLM 116 is to output for a security vulnerability 110. The semantics 230 may, for instance, provide information as to what the different values the LLM 116 can choose for various parts of the response 118, what the different values mean, and why the LLM 116 may choose one value as opposed to another value. The parts of the response 118 can include the audit value 120 (i.e., the indication as to whether the security vulnerability 110 is a true positive or not), such that the semantics 230 can include when these different values should be chosen as the audit value 120.

The response semantics 230 can include information regarding other parts of the response 118 as well. For instance, such other parts of the response 118 can be considered as comments that include the justification of the LLM 116 as to its reasoning in selecting the audit value 120 (e.g., the reasoning as to why the LLM 116 indicated the vulnerability 110 was an actual vulnerability or not) and a recommended fix for security vulnerability 110. In this case, the response semantics 230 can provide the information that the LLM 116 is expected to provide when generating the response 118.

For each value from which the LLM 116 can choose as the audit value 120, the response semantics 230 may provide information that the LLM 116 is expected to provide when choosing that value. For instance, if the audit value 120 is an indication that the vulnerability 110 is not a true positive, the response semantics 230 can provide the information that the LLM 116 is to provide to explain why the vulnerability 110 is not a true positive. This information can be different from the information that the LLM 116 is to provide when the audit value 120 indicates that the vulnerability 110 is a true positive.

The system prompt 222 can include general information 232 regarding how the LLM 116 is to generate the response 118 for a security vulnerability 110, which is not specific to the vulnerability 110. The general information 232 can be considered as instructions as to what the LLM 116 is to do in order to fulfill the statement of purpose 226. These instructions may provide particular information as to the overall principles that the LLM 116 is to keep in mind when generating the response 118. One such type of information includes policy decisions that the LLM 116 is to take into account when performing the auditing process.

Examples of such policy decisions include how the LLM 116 should respond to a vulnerability 110 that is detected in test code as opposed to production code; how the LLM 116 should respond when it encounters data that has been validated or sanitized in a particular way; and how the LLM 116 should respond when it does not fully understand something. By including such policy statements in the system prompt 222, the accuracy and consistency of the results can be optimized. Such information is not part of the statement of purpose 226 (i.e., what the role of the LLM 116 is and what the LLM 116 is expected to do), but rather general information governing how the LLM 116 is to achieve its role that is not specific to any particular vulnerability category 202, for instance.

Furthermore, the instructions can include particular knowledge that is not part of the LLM 116's base knowledge or a reiteration of things the LLM 116 does know in principle, with the purpose of making the LLM 116 specifically focus on this information. A concrete example of this case, for instance, is to instruct the LLM 116 that when a control flow is interrupted by throwing a particular type of exception in the case of data being invalid, such interruption effectively constitutes validation.

The instructions can also include particular facts about the analysis tool that detected the issue (i.e., the security vulnerability 110), which are relevant to performing its task. For example, the security testing 106 that was performed to identify the security vulnerability 110 may have employed a dataflow analyzer that is path-insensitive. Therefore, the LLM 116 should be aware that the flow assumed by the security testing 106 in this case may in reality be potentially logically impossible and that the security could be a false positive for that reason.

The user prompt 224 can include the security vulnerability 110 itself, as well as the vulnerability category 202, the responsible source code 204, and the traces 206. The security vulnerability 110, the vulnerability category 202, the responsible source code 204, and/or the traces 206 may be represented in the user prompt 224 in a format different than in which they are represented in the information 108 pertaining to the security vulnerability 110. Additional metadata regarding the security vulnerability 110 (i.e., metadata in addition to and/or in lieu of the vulnerability category 202 and the traces 206 that are provided in the information 108) may further be included in the user prompt 224. In the example, such additional metadata included in the user prompt 224 includes supplemental information 234 and a summary 236.

The supplemental information 234 is in regard to how the LLM 116 is to generate the response 118 for the security vulnerability 110, and can be specific to the category 202 of the security vulnerability 110. Therefore, the supplemental information 234 is in comparison to the general information 232 of the system prompt 222, which is not specific to the vulnerability category 202 or the vulnerability 110 itself. The supplemental information 234 may, for instance, provide special instructions for the LLM 116 to consider when generating the response 118, which are particular to the vulnerability category 202. For example, there may be instructions as to SQL injection, for instance, that are not relevant to a different vulnerability category 202, and thus included in the supplemental information 234.

The overall summary 236 is an overall summary of the prompt 224. The summary 236 is configured to convey to the LLM 116 what information is most important when generating the response 118 for the security vulnerability 110. The summary 236 may be particular to the category 202 of the vulnerability 110, and may reference the most relevant of the source code 204, and/or the traces 206, as indicated by the security testing that identified the vulnerability 110. The summary 236 may further underscore to the LLM 116 that it is to use the provided output format 228 when generating the response 118, and that the LLM 116 is to consider the vulnerability 110 in question and not any other vulnerabilities that may be present.

FIG. 2C shows an example response 118 for a security vulnerability 110 that the LLM 116 may generate and provide as output in response to a prompt 114 for the vulnerability 110. The response 118 can be an XML file, a JSON file, or another type of markup language file. The response 118 includes the audit value 120 as has been described (e.g., an indication as to whether the security vulnerability 110 is an actual vulnerability or not). An example of the audit value 120 is “<value>Exploitable</value>”, which indicates that the security vulnerability 110 identified by the security testing is a true positive in that it may indeed be able to be exploited if the program 104 were run.

The response 118 can include a justification 242 as to why the LLM 116, for instance, has indicated that the security vulnerability 110 is an actual vulnerability or not. The justification 242 may be in human or in computer-readable form. The justification 242 is the reasoning of the LLM 116 in selecting the specific audit value 120 in the response 118 that the LLM 116 generated for the security vulnerability 110.

The response 118 can include, in the case in which the security vulnerability 110 has been indicated by the LLM 116 as an actual security vulnerability, a recommended fix 244 to resolve the vulnerability 110. The justification 242 and the recommended fix 244 may be included in the same part of the response 118, such as a comments portion of the response 118, or may be included in a different part of the response 118.

FIG. 2D shows an example recommended fix 244 that may be included in the response 118. The recommended fix 244 can include a comment 262, replacement source code 264, a reference to a replacement library file 266, and/or a patch pull request 268. The comment 262 generally provides instruction as to how to resolve the security vulnerability in the source code 102 of the program 104, and can pertain to whichever of the replacement source code 264, the reference to the replacement library file 266, and the patch pull request 268 is also part of the recommended fix 244 (where more than of these can be included).

The replacement source code 264 is what the LLM 116 recommends should substitute the responsible source code 204 (i.e., the vulnerable source code). When the recommended fix 244 can be achieved by changing or replacing portions of the source code 102, the recommended fix 244 can, therefore, include replacement source code 264.

The replacement library file 266 to which a reference can be provided in the recommended fix 244 is what the LLM 116 recommends should substitute an existing dependency file that is vulnerability and is presently being used by the program 104. If a reference to a replacement library file 266 is part of the recommended fix 244, the recommended fix 244 may still include replacement source code 264, though, depending upon whether or not the referenced replacement library file 266 requires changes to the source code 102 for proper integration.

The patch pull request 268, by comparison, is for pulling particularly identified patch source code, and in some situations the library file 266 that a reference to which is provided in the recommended fix 244 as well, for merging with the source code 102 when building the executable version of the program 104.

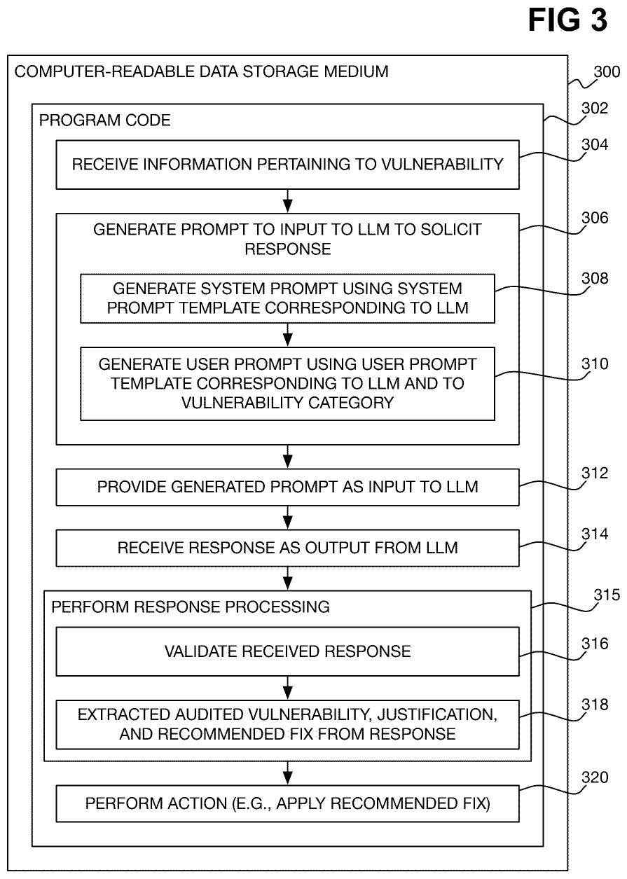

FIG. 3 shows an example non-transitory computer-readable data storage medium 300 storing program code 302 executable by a processor to perform processing to analyze a security vulnerability 110 that has been identified by security testing. The processing includes receiving the information 108 pertaining to the security vulnerability 110 (304). The information 108 can include the security vulnerability 110 as well as the responsible source code 204.

The processing includes generating, based on the information 108 pertaining to the security vulnerability 110, the prompt 114 to input to the LLM 116 (306), in order to solicit a response 118 from the LLM 116 as has been described (e.g., to solicit a response 118 that includes an audit value 120, a justification 242, and a recommended fix 244). Generating the prompt 114 can include generating the system prompt 222 that is not specific to the security vulnerability 110 in question (308), using a system prompt template corresponding to the LLM 116.

For example, the system prompt template may be specified in accordance with a template language such as (but not limited to) the FreeMarker Template Language (FTL), and correspondingly rendered by a templating engine such as the FreeMarker templating engine available from the Apache Software Foundation to generate the system prompt 222. In this case, the system prompt template can include sections of text that will be copied to by the system prompt 222; interpolation sections that are replaced with calculated values in the system prompt 222; tags that are instructions processed by the templating engine in generating the system prompt 222; and comments that are ignored by the engine and not included in the system prompt 222.

Other examples of templating engines that may be employed include Apache Velocity, available from the Apache Software Foundation; Thymeleaf, available at www.thymeleaf.org; Mustache, available at mustache.github.io; Handlebars, available at handlebarsjs.com; Jinja and Jinja2, available at jinja.palletsprojects.com; and Pug (formerly Jade), available at pugjs.org; among others.

Generating the prompt 114 can further include generating the user prompt 224 that is specific to the vulnerability 110 (310), using a user prompt template corresponding to the category 202 of the vulnerability 110 and which may also correspond to the LLM 116. As with the system prompt template that is rendered to generate the system prompt 222, the user prompt template is rendered to generate the user prompt 224. The user prompt template may therefore also be specified in accordance with a template language such as FTL, and rendered by a templating engine to generate the user prompt 224.

The processing includes providing the prompt 114 (e.g., the generated prompts 222 and 224) as input to the LLM 116 (312), and receiving a response 118 as output from the LLM 116 (314). The processing can include performing LLM response processing on the response 118 (315). Such LLM response processing can include validating the response 118 that has been received (316). For example, validation of the response 118 can include determining whether the response 118 conforms to the output format 228 specified by the system prompt 222. The LLM 116, for instance, may not adhere to the expected format 228 when generating the response 118, in which case the processing of FIG. 3 may be prematurely terminated. Validating the response 118 may also include determining whether the LLM response 118 satisfies criteria other than the output format 228, and modifying the response 118 if the criteria are not satisfied.

Assuming that the response 118 for the security vulnerability 110 is in the expected output format 228, the LLM response processing can include then extracting the audit value 120, the justification 242, and in the case in which the vulnerability 110 is an actual vulnerability as indicated by the audit value 120, the recommended fix 244 (318). The processing can finally include performing an action related to the source code 102 for the program 104 based on the received response 118 (320). For example, in the case in which the security vulnerability 110 has been identified as a true positive, the recommended fix 244 can be applied to resolve the vulnerability 110.

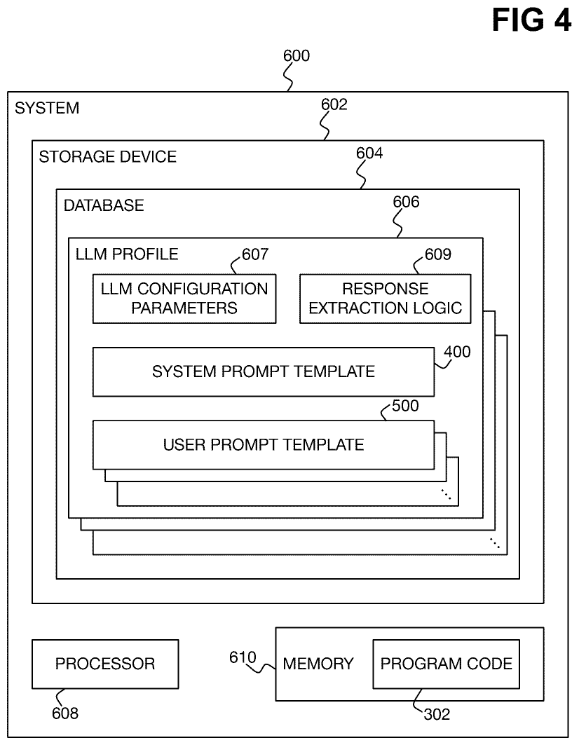

FIG. 4 shows an example computing system 600 for analyzing security vulnerabilities 110 of a program 104, as may have been identified by security testing performing on the source code 102 of the program 104. The system 600 can be implemented as one or more computing devices, such as desktop, server, laptop, and notebook computers, among other types of computing devices. For instance, the system 600 can be implemented as a distributed system involving a number of computing devices that may be load balanced. As another example, however, the system 600 can reside on only a single server, a single client, or in combination as a client-server architecture.

The system 600 include a storage device 602 that stores a database 604. The database 604 includes LLM profiles 606 that respectively correspond to different LLMs 116 that can be used to analyze security vulnerabilities 110 of a program 104 that have been identified by security testing.

The corresponding LLM profile 606 for an LLM 116 includes a system prompt template 400 used to generate the system prompt 222 to provide (along with a user prompt 224) as input to that LLM 116 to solicit a response 118 for a security vulnerability 110. The same system prompt 222 may not be optimal for different LLMs 116. Therefore, having different system prompt templates 400 for different LLMs 116 ensures that a system prompt 222 can be generated that is specific to the LLM 116 that has been selected to analyze a security vulnerability 110.

The LLM profile 606 for an LLM 116 can include LLM configuration parameters 607 and response extraction logic 609. The LLM configuration parameters 607 include values for any configurable or switchable settings of the LLM 116 that are to be provided when the prompt 114 is input into the LLM 116. The response extraction logic 609 can include executable code, such as in the form of script, or can include rules or another type of logic, and realizes the LLM response processing that is performed when the LLM response 118 is received. The logic 609 can differ for different LLMs 116, and thus is included as part of the LLM profile 606 for each LLM 116.

The LLM profile 606 for an LLM 116 also includes user prompt templates 500 respectively corresponding to different security vulnerability categories 202. Each user prompt template 500 is thus specific to both a given vulnerability category 202 as well as to a particular LLM 116. Here, too, the same user prompt 224 for a security vulnerability 110 in a given category 202 may not be optimal for different LLMs 116. Therefore, for a given category 202 of security vulnerability 110, having different user profile templates 500 for different LLMs 116 ensures that a user prompt 224 can be generated that is specific to the LLM 116 that has been selected to analyze a security vulnerability in that category 202.

The system 600 includes a processor 608 and a memory 610 that stores the program code 302 which is executable by the processor 608 to perform the processing that has been described. In the implementation of FIG. 4, since the database stores profiles 606 for multiple LLMs 116, when the program code 302 is executed, a user may be able to select which LLM 116 is to be used to individually analyze the identified security vulnerabilities 110.

As another example, a default LLM 116 may be specified by a different user (e.g., an administrator), and the user who is seeking to analyze the identified security vulnerabilities 110 may or may not be able to override the default LLM 116. As yet another example, multiple LLMs 116 may be used to analyze the identified security vulnerabilities 110. For a given vulnerability 110, a different prompt 114 (e.g., both a system prompt 222 and a user prompt 224) is generated for each LLM 116 based on its corresponding LLM profile 606 and provided as input to the LLM 116 in question. The responses 118 that are received from the LLMs 116 for the vulnerability 110 may then be integrated to generate a single unified or overall response 118 for that vulnerability 110, for instance.

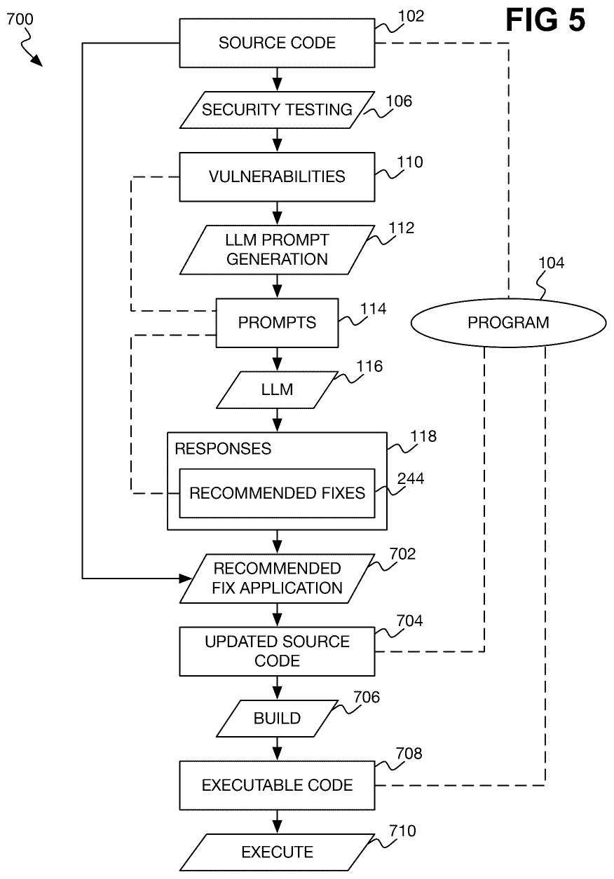

FIG. 5 shows an example process 700 for using an LLM 116 to analyze identified security vulnerabilities 110 of a program 104, and for then using the results of that analysis to update source code 102 of the program 104 so that when the program 104 is ultimately executed the vulnerabilities 110 are less likely to are unable to be exploited. In the example, and as has been described, the source code 102 itself can first be subjected to security testing (106) to identify the vulnerabilities 110.

LLM prompts 114 are then respectively generated (112) for the security vulnerabilities 110, and individually provided as input to the LLM 116. In the example of FIG. 5, the LLM 116 in response specifically provides as output the LLM responses 118, which include at least recommended fixes 244 for the vulnerabilities 110 in the depicted example. The recommended fix 244 for a given vulnerability 110 can, as has been described in relation to FIG. 2D, include replacement source code 264 for the source code 204 responsible for the vulnerability 110.

Application (702) of the recommended fixes 244 for the security vulnerabilities 110 to the source code 102 therefore yields updated source code 704 of the program 104 in which the vulnerabilities 110 have been resolved or at least ameliorated. The program 104 can then be built (706) based on the updated source code 704, such as by, for example, compiling the source code 704, to yield executable code 708 of the program 104. When the executable code 708 is then run or executed (710), the program 104 is thus less susceptible (or not susceptible at all) to the security vulnerabilities 110, as compared to if the executable code 708 were generated based on the original source code 102. Security is accordingly improved.

Techniques have been described herein for leveraging LLMs 116 to analyze security vulnerabilities 110 of a program 104 that have been identified by security testing, such as by security testing performed on the source code 102 of the program 104. The usage of LLMs 116 in the described manner can identify which vulnerabilities 110 are true positives, and can further provide recommended fixes 244 to resolve the vulnerabilities 110. The recommended fixes 244 may be automatically applied, such that subsequent running of the program 104 after the fixes 244 have been applied is more secure.

We claim:

1. A method comprising:
receiving, by a processor, information pertaining to a security vulnerability of a program identified by security testing, the information including at least the security vulnerability and source code of the program responsible for the security vulnerability;
generating, by the processor and based on the information pertaining to the security vulnerability, a prompt to input to a large language model (LLM), the prompt generated to solicit a response from the LLM including at least whether the security vulnerability is an actual security vulnerability;
providing, by the processor, the generated prompt as input to the LLM;
receiving, by the processor, the response as output from the LLM; and
performing, by the processor, an action related to the source code of the program based on the received response.

2. The method of claim 1, wherein the response from the LLM that the prompt is generated to solicit further includes, in a case in which the security vulnerability is an actual security vulnerability, a recommended fix to resolve the security vulnerability.

3. The method of claim 2, wherein the response received as output from the LLM indicates that the security vulnerability is an actual security vulnerability,
and wherein performing the action based on the received response comprises applying the recommended fix to resolve the security vulnerability.

4. The method of claim 3, wherein the recommended fix comprises replacement source code for the source code responsible for the security vulnerability,
and wherein applying the recommended fix comprises replacing the source code responsible for the security vulnerability with the replacement source code.

5. The method of claim 3, wherein the recommended fix comprises a reference to a replacement library file for an existing library file that is used when building an executable version of the program from the source code,
and wherein performing the action based on the received response comprises replacing the existing library file with the replacement library file when building the executing version of the program from the source code.

6. The method of claim 3, wherein the recommended fix comprises one or multiple of:
a comment including an instruction to a user on how to resolve the security vulnerability;
replacement source code for the source code responsible for the security vulnerability;
a reference to a replacement library file for an existing file to be used when building an executable version of the program from the source code; and
a patch pull request to pull patch source code for merging with the source code when building the executable version of the program.

7. The method of claim 1, wherein the response from the LLM that the prompt is generated to solicit further includes a justification as to why the LLM has indicated that the security vulnerability is an actual security vulnerability or not.

8. The method of claim 1, wherein generating the prompt to input to the LLM to solicit the response from the LLM comprises:
generating a system prompt that is not specific to the security vulnerability identified by the security testing; and
generating a user prompt that is specific to the security vulnerability identified by the security testing performed.

9. The method of claim 8, wherein the system prompt comprises one or more of:
a statement of purpose of the LLM as to a role of the LLM and what the LLM is expected to do in generating the response;
an output format of the response that the LLM is to output;
semantics of the response that the LLM is to output; and
general information regarding how the LLM is to generate the response that is not specific to the security vulnerability.

10. The method of claim 8, wherein the user prompt comprises:
the security vulnerability identified by the security testing; and
the source code responsible for the security vulnerability.

11. The method of claim 10, wherein the user prompt further comprises one or more of:
a category of the security vulnerability identified by the security testing;
one or more traces generated by the security testing when identifying the security vulnerability, the one or more traces included in the received information pertaining to the security vulnerability;
supplemental information regarding how the LLM is to generate the response that is specific to the category of the security vulnerability; and
a summary of the user prompt to be input to the LLM, the summary configured to convey to the LLM what information is most important in generating the response.

12. A non-transitory computer-readable data storage medium storing program code executable by a processor to perform processing comprising:
receiving information pertaining to a security vulnerability of a program identified by security testing, the information including at least the security vulnerability and source code of the program responsible for the security vulnerability;
generating, based on the information pertaining to the security vulnerability, a prompt to input to a large language model (LLM), the prompt generated to solicit a response from the LLM including:
whether the security vulnerability is an actual security vulnerability;
a justification as to why the LLM has indicated that the security vulnerability is an actual security vulnerability or not; and
in a case in which the security vulnerability is an actual security vulnerability, a recommended fix to resolve the security vulnerability;
providing the generated prompt as input to the LLM;
receiving the response as output from the LLM; and
performing an action related to the source code of the program based on the received response.

13. The non-transitory computer-readable data storage medium of claim 12, wherein the response received as output from the LLM indicates that the security vulnerability is an actual security vulnerability,
and wherein performing the action based on the received response comprises applying the recommended fix to resolve the security vulnerability.

14. The non-transitory computer-readable data storage medium of claim 12, wherein generating the prompt to input to the LLM to solicit the response from the LLM comprises:
generating a system prompt that is not specific to the security vulnerability identified by the security testing; and
generating a user prompt that is specific to the security vulnerability identified by the security testing.

15. The non-transitory computer-readable data storage medium of claim 14, wherein generating the system prompt comprises:
rendering a system prompt template corresponding to the LLM to generate the system prompt.

16. The non-transitory computer-readable data storage medium of claim 14, wherein generating the user prompt comprises:
rendering a user prompt template corresponding to the LLM and to a category of the security vulnerability identified by the security testing to generate the user prompt.

17. The non-transitory computer-readable data storage medium of claim 12, wherein the response is received from the LLM in a format specified by the generated prompt input to the LLM,
and wherein the processing further comprises extracting, from the response, whether the security vulnerability is an actual security vulnerability, the justification as to why the LLM has indicated the security vulnerability is an actual security vulnerability or not, and in case in which the security vulnerability is an actual security vulnerability, the recommended fix to resolve the security vulnerability.

18. The non-transitory computer-readable data storage medium of claim 12, wherein the processing further comprise validating the response received as output from the LLM to determine whether the response conforms to a format specified by the generated prompt input to the LLM.

19. A system comprising:
a memory storing program code; and
a processor configured to execute the program code to perform processing comprising:
receiving information pertaining to a plurality of security vulnerabilities in a program identified by security testing, the information including, for each security vulnerability, the security vulnerability and source code of the program responsible for the security vulnerability;
for each security vulnerability, generating, based on the information pertaining to the security vulnerability, a prompt to input to a large language model (LLM), the prompt generated to solicit a response from the LLM including:
whether the security vulnerability is an actual security vulnerability;
a justification as to why the LLM has indicated that the security vulnerability is an actual security vulnerability or not; and
in a case in which the security vulnerability is an actual security vulnerability, a recommended fix to resolve the security vulnerability;
providing the generated prompt for each security vulnerability as input to the LLM;
receiving the response for each security vulnerability as output from the LLM; and
performing an action related to the source code of the program based on the received response for each security vulnerability.

20. The system of claim 19, wherein the LLM is a selected LLM of a plurality of LLMs,
wherein the system further comprises a storage device storing a database of profiles corresponding to the LLMs, each profile including:
a system prompt template for a corresponding LLM; and
a plurality of user prompt templates for the corresponding LLM and respectively corresponding to a plurality of security vulnerability categories,
and wherein generating, for each security vulnerability, the prompt to input to the LLM to solicit the response from the LLM comprises:
generating a system prompt that is not specific to the security vulnerability identified by the security testing performed on the source code, using the system prompt template for the selected LLM; and
generating a user prompt that is specific to the security vulnerability identified by the security testing, using the user prompt template for the selected LLM and corresponding to a category of the security vulnerability.
